(19) United States
(12) Patent Application Publication
(10) Pub. No.: US 2020/0050306 A1
(43) Pub. Date: Feb. 13, 2020

(54) SENTIMENT-BASED INTERACTION METHOD AND APPARATUS

(71) Applicant: Microsoft Technology Licensing, LLC, Redmond, WA (US)

(72) Inventors: Tian Tan, Redmond, WA (US); Justin Ting, Redmond, WA (US); Yuan ZHANG, Redmond, WA (US); Lei Ding, Redmond, WA (US)

(21) Appl. No.: 16/342,510

(22) PCT Filed: Nov. 30, 2016
(86) PCT No.: PCT/CN2016/108010

§ 371 Date: Apr. 16, 2019

(51) Int. Cl. G06F 3/048; G06F 3/01; G06F 9/451

(52) U.S. Cl. CPC G06F 3/048; G06F 2203/011; G06F 9/451; G06F 3/011

(57) ABSTRACT

A method for interaction is provided. The method comprises: receiving a first content through a user interface (UI) of an application; sending the first content to a server; receiving a second content in response to the first content and a UI configuration-related data from the server; updating the UI based on the UI configuration-related data; and outputting the second content through the updated UI.

### BACKGROUND

Along with the development of artificial intelligence (AI) technology, personal assistant applications based on the AI technology are available to users. A user may interact with a personal assistant application installed at a user device to let the personal assistant application deal with various matters, such as searching information, chitchatting, setting a date, and so on. One challenge for such personal assistant applications is how to establish a closer connection with the user in order to provide better user experience.

### SUMMARY

The following summary is provided to introduce a selection of concepts in a simplified form that are further described below in the detailed description. This summary is not intended to identify key features or essential features of the claimed subject matter, nor is it intended to be used to limit the scope of the claimed subject matter.

According to an embodiment of the subject matter described herein, a sentiment-based interaction method comprises: receiving a first content through a user interface (UI) of an application at a client device; sending the first content to a server; receiving a second content in response to the first content and a UI configuration-related data from the server; updating the UI based on the UI configuration-related data; and outputting the second content through the updated UI.

According to an embodiment of the subject matter, a sentiment-based interaction method comprises receiving a first content from a client device; determining a second content in response to the first content; and sending the second content and a UI configuration-related data to the client device.

According to an embodiment of the subject matter, an apparatus for interaction comprises an interacting module configured to receive a first content through a UI of an application and a communicating module configured to transmit the first content to a server and receive a second content in response to the first content and a UI configuration-related data from the server, the interacting module is further configured to update the UI based on the UI configuration-related data, and output the second content through the updated UI.

According to an embodiment of the subject matter, a system for interaction comprises a receiving module configured to receive a first content from a client device; a content obtaining module configured to obtaining a second content in response to the first content; and a transmitting module configured to transmit the second content and a UI configuration-related data to the client device.

According to an embodiment of the subject matter, a computer system, comprises: one or more processors; and a memory storing computer-executable instructions that, when executed, cause the one or more processors to receive a first content through a UI of an application; send the first content to a server; receive a second content in response to the first content and a UI configuration-related data from the server; update the UI based on the UI configuration-related data; and output the second content through the updated UI.

According to an embodiment of the subject matter, a computer system, comprises: one or more processors; and a memory storing computer-executable instructions that, when executed, cause the one or more processors to receive a first content from a client device; determine a second content in response to the first content; and send the second content and a UI configuration-related data to the client device.

According to an embodiment of the subject matter, a non-transitory computer-readable medium having instructions thereon, the instructions comprises: code for receiving a first content through a UI of an application; code for sending the first content to a server; code for receiving a second content in response to the first content and a UI configuration-related data from the server; code for updating the UI based on the UI configuration-related data; and code for outputting the second content through the updated UI.

According to an embodiment of the subject matter, a non-transitory computer-readable medium having instructions thereon, the instructions comprises: code for receiving a first content from a client device; code for determining a second content in response to the first content; and code for sending the second content and a UI configuration-related data to the client device.

### BRIEF DESCRIPTION OF THE DRAWINGS

Various aspects, features and advantages of the subject matter will be more apparent from the detailed description set forth below when taken in conjunction with the drawings, in which use of the same reference number in different figures indicates similar or identical items.

FIG. 1A-1B each illustrates a block diagram of an exemplary environment where embodiments of the subject matter described herein may be implemented;

FIG. 2 illustrates a flowchart of an interaction process among a user, a client device and a cloud according to an embodiment of the subject matter;

FIG. 3A-3F each illustrates a schematic diagram of a UI according to an embodiment of the subject matter;

FIG. 4-5 each illustrates a flowchart of an interaction process among a user, a client device and a cloud according to an embodiment of the subject matter;

FIG. 6-7 each illustrates a flowchart of a process for sentiment based interaction according to an embodiment of the subject matter;

FIG. 8 illustrates a block diagram of an apparatus for sentiment-based interaction according to an embodiment of the subject matter.

FIG. 9 illustrates a block diagram of a system for sentiment-based interaction according to an embodiment of the subject matter.

FIG. 10 illustrates a block diagram of a computer system for sentiment-based interaction according to an embodiment of the subject matter.

### DETAILED DESCRIPTION

The subject matter described herein will now be discussed with reference to example embodiments. It should be understood these embodiments are discussed only for the purpose of enabling those skilled persons in the art to better understand and thus implement the subject matter described herein, rather than suggesting any limitations on the scope of the subject matter.

As used herein, the term “includes” and its variants are to be read as open terms that mean “includes, but is not limited to”. The term “based on” is to be read as “based at least in part on”. The terms “one embodiment” and “an embodiment” are to be read as “at least one implementation”. The term “another embodiment” is to be read as “at least one other embodiment”. The term “a” or “an” is to be read as “at least one”. The terms “first”, “second”, and the like may refer to different or same objects. Other definitions, explicit and implicit, may be included below. A definition of a term is consistent throughout the description unless the context clearly indicates otherwise.

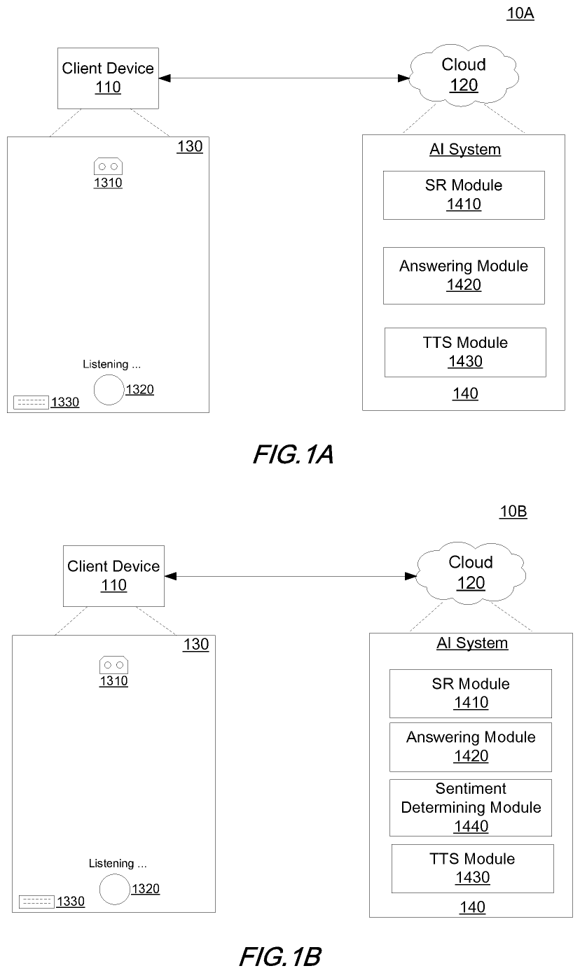

FIG. 1A illustrates an exemplary environment 10A where embodiments of the subject matter described herein can be implemented. It is to be appreciated that the structure and functionality of the environment 10A are described only for the purpose of illustration without suggesting any limitations as to the scope of the subject matter described herein. The subject matter described herein can be embodied with a different structure or functionality.

As shown in FIG. 1A, a client device 110 may be connected to a cloud 120 via a network. A user of the client device 110 may operate through a user interface (UI) 130 of a personal assistant application running on the client device 110. The personal assistant application may be an AI-based application, which may interact with the user through the UI 130. As an exemplary implementation, the UI 130 of the application may include an animation icon 1310, which may represent the identity of the application. The UI 130 may include a microphone icon 1320, through which the user may input his speeches to the application. The UI 130 may include a keyboard icon 1330, through which the user is allowed to input text. The UI 130 may have a background color, which typically may be black. Although items 1310 to 1330 are shown in the UI 130 in FIG. 1, it should be appreciated that there may be more or less items in the UI 130, the names of the items may be different, and the subject matter is not limited to a specific number of items or specific names of items.

A user may interact with the personal assistant application through the UI 130. In an implementation scenario, the user may press the microphone icon 1320 and input his instruction by speech. For example, the user may speak to the application through the UI 130 that “how is the weather today”. This speech may be transmitted from the client device 110 to a cloud 120 via the network. An artificial intelligence (AI) system 140 may be implemented at the cloud 120 to deal with the user input and provide a response, which may be transmitted from the cloud 120 to the client device 110 and may be output to the user through the UI 130. As shown in FIG. 1A, the speech signal “how is the weather today” may be recognized into text at the speech recognition (SR) module 1410. At the answering module 1420, the recognized text may be analyzed and an appropriate response may be obtained. For example, the answering module 1420 may obtain the response such as the weather information from a weather service function in the cloud 120 or by means of a searching engine. It should be appreciated that the searching engine may be implemented in the answering module or may be a separate module, which is not shown for sake of simplicity. The subject matter is not limited to the specific structure of the cloud. The response such as the weather information, for example “today is sunny, 26 celsius degree, breeze”, may be converted from a text information to a speech signal at a text to speech (TTS) module 1430. The speech signal may be transmitted from the cloud 120 to the client device 110 and may be presented to the user through the UI 130 by means of a speaker. Alternatively or additionally, text information about the weather may be sent from the cloud 120 to the client device 110 and displayed on the UI 130.

It should be appreciated that the cloud 120 may also be referred to the AI system 140. The term “cloud” is a known term for those skilled in the art. The cloud 120 may also be referred to as a server, but this does not mean that the cloud 120 is implemented by a single server, actually the cloud 120 may include various services or servers.

In an exemplary implementation, the answering module 1420 may classify the user inputted content into different types. A first type of user input may be related to operation of the client device 110. For example, if the user input is “please set an alarm clock at 6 o'clock”, the answering module 1420 may identify the user's instruction and send an instruction for setting the alarm clock to client device, and the personal assistant application may set the alarm clock on the client device and provide a feedback to the user through the UI 130. A second type of user input may be related to those that may be answered based on the databases of the cloud 120. A third type of user input may be related to chitchat. A fourth type of user input may be related to those for which the answers need to be obtained through searching of the internet. For any one of the types, an answer in response to the user input may be obtained at the answering module 1420, and may be sent back to the personal assistant application at the client device 110.

FIG. 1B illustrates an exemplary environment 10B where embodiments of the subject matter described herein can be implemented. Same label numbers in FIG. 1B and FIG. 1A denote similar or same elements. It is to be appreciated that the structure and functionality of the environment 10B are described only for the purpose of illustration without suggesting any limitations as to the scope of the subject matter described herein. The subject matter described herein can be embodied with a different structure or functionality.

As shown in FIG. 1B, the AI system 140 or the cloud 120 may include a sentiment determining module 1440. The sentiment determining module 1440 may determine sentiment data based on the content obtained at the answering module 1420. For example, the content obtained at the answering module 1420 in response to the user input may be text such as sentences, reviews, recommendations, news and so on. An example of the sentence may be a text response from an AI chat-bot, may be a text answer in response to the user's input such as the stock information, or the like. The sentiment determining module 1440 may also determine the sentiment data based on the user inputted content in addition to or instead of the content obtained at the answering module 1420. The sentiment data may include sentiment types such as positive, negative or neutral and sentiment intensity such as score. The sentiment types may be in various formats, for example, the sentiment types may include very negative, negative, neutral, positive, very positive, and the sentiment types may include happy, anger, sadness, disgust, neutral and so on. Various techniques for calculating the sentiment data based on the content may be employed at the sentiment determining module 1440. As an example, a lexicon-based method may be employed to determine the sentiment data. As another example, a machine learning-based method may be employed to determine the sentiment data. It should be appreciated that the subject matter is not limited to specific process for determining the sentiment data, and is not limited to the specific types of the sentiment data.

Other factors may be utilized at the sentiment determining module 1440 to calculate the sentiment data. As an example, the user may set a customized or desired sentiment, which may be sent to the cloud 120 and may be utilized by the sentiment determining module 1440 as a factor to determine the sentiment data. As another example, the user's facial images may be captured by the personal assistant application via a front camera of the client device, and may be sent to the cloud 120. A visual analysis module, which is not shown in the figure for sake of simplicity, may identify the emotion of the user by analyzing the facial images of the user. The emotion information of the user may be utilized by the sentiment determining module 1440 as a factor to determine the sentiment data.

In an implementation, the sentiment data obtained at the sentiment determining module 1440 may be utilized by the TTS module 1430 to generate a speech having a sentimental tone and/or intonation. And the sentimental speech may be sent back from the cloud 120 to the client device 110 and presented to the user through the UI 130 via a speaker.

It should be appreciated that although various modules and functions are described with reference to FIGS. 1A and 1B, not all of the functions and/or modules are necessary in a specific implementation and some functions may be implemented in one module and may also be implemented in multiple modules. For example, the user inputted content sent from the client device 110 to the cloud 120 may be a speech signal and may also be text, the SR module 1410 is not necessary to operate when the user inputted content is text. The responded content sent from the cloud 120 to the client device 110 may be text data output at the answering module 1420, and may also be a speech signal output at the TTS module 1430. The TTS module 1430 is not necessary to operate when only text data are sent back to the client device 110. The function of determining sentiment data may be implemented at the answering module 1420, and in this case the sentiment determining module 1440 is not necessary to be a separate module.

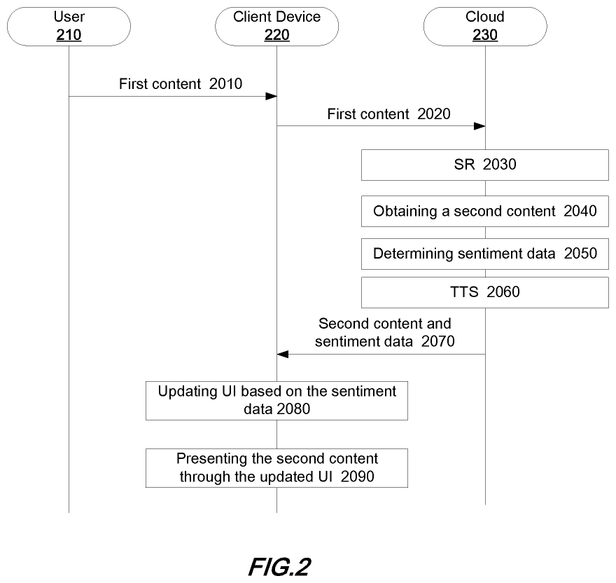

FIG. 2 illustrates an interaction process among a user, a client device and a cloud according to an embodiment of the subject matter.

At step 2010, a user 210 may input a first content through a UI of an application such as a personal assistant application at a client device 220. In other words, the first content may be received through the UI of the application at the client device 220. The first content may be a speech signal or a text data, or may be in any other suitable format.

At step 2020, the first content 2020 may be transmitted from the client device to a cloud 230, which may also be referred to as a server 230.

At step 2030, if the first content is a speech signal, a speech recognition (SR) may be performed to the speech signal to obtain text data corresponding to the first content. As another implementation, the SR process may also be implemented at the client device 220, then the first content in text format may be transmitted from the client device 220 to the cloud 230.

At step 2040, a second content may be obtained in response to the first content at the cloud 230. And at step 2050, a sentiment data may be determined based on the second content. The sentiment data may also be determined based on the first content, or based on both the first content and the second content.

At step 2060, a text to speech (TTS) process may be performed to the second content in text format to obtain the second content in speech format.

At step 2070, the second content in either text format or speech format or both formats together with the sentiment data may be transmitted from the cloud 230 to the client device 220.

At step 2080, the UI may be updated based on the sentiment data, and at step 2090, the second content may be output or presented to the user through the updated UI.

The UI may be updated by changing configuration of at least one element of the UI based on the sentiment data. Examples of the elements of the UI may comprise color, motion, icon, typography, relative position, taptic feedback, etc.

The sentiment data may include at least one sentiment type and corresponding sentiment intensity of each sentiment type. As an example, the sentiment type may be classified as positive, negative and neutral, and a score is provided for each of the types to indicate the intensity of the sentiment. The sentiment data may be mapped to UI configuration data such as configuration data of at least one element of the UI, so that the UI may be updated based on the sentiment data.

Table 1 illustrates an exemplary mapping between the sentiment data such as the sentiment type and sentiment score and the UI configurations. As shown in table 1, each score range of each sentiment type may be mapped into a UI configuration. It should be appreciated that the numbers of sentiment types, score ranges and UI configurations is not limited to the specific number shown in table 1, there may be more or less number of sentiment types, score ranges or UI configurations. Table 2 illustrates an exemplary mapping between the sentiment data and the UI configurations. As shown in table 2, each sentiment type may be mapped into a UI configuration. Table 3 illustrates an exemplary mapping between the sentiment data and the UI configurations. As shown in table 3, each combination of multiple sentiment types such as two types may be mapped into a UI configuration. There may be more than one sentiment type in the sentiment data accompanying the second content. It should be appreciated that there may be more or less types in table 2 or 3, and one combination may include more or less sentiment types in table 3. The tables 1 to 3 may be at least partially combined to define a suitable mapping between the sentiment data and the UI configuration.

TABLE 1

| | Type | | | | | | | | |
|---|---|---|---|---|---|---|---|---|---|
| | 1 | | | 2 | | | 3 | | |
| Score range | 1 | 2 | 3 | 1 | 2 | 3 | 1 | 2 | 3 |
| UI configuration | 1 | 2 | 3 | 4 | 5 | 6 | 7 | 8 | 9 |

TABLE 2

| Type | 1 | 2 | 3 | 4 | 5 |
|---|---|---|---|---|---|
| UI configuration | 1 | 2 | 3 | 4 | 5 |

TABLE 3

| | Type | | | | | | | | | |
|---|---|---|---|---|---|---|---|---|---|---|
| | 1&2 | 1&3 | 1&4 | 1&5 | 2&3 | 2&4 | 2&5 | 3&4 | 3&5 | 4&5 |
| UI configuration | 1 | 2 | 3 | 4 | 5 | 6 | 7 | 8 | 9 | 10 |

Taking the above mentioned weather inquiry as an example, the first content inputted by the user may be “how is the weather today”, the second content obtained at the cloud in response to the first content may be “today is sunny, 26 celsius degree, breeze”, the sentiment data determined based on the second content at the cloud may be “type: positive, score: 8”, assuming that the sentiment types includes positive, negative and neutral and the score of a type ranges from 1 to 10. After receiving the second content and the sentiment data, the UI configuration may be updated based on the sentiment data.

TABLE 4

| | Type | | | | | | |
|---|---|---|---|---|---|---|---|
| | 1: positive | | | 2: negative | | | 3: neutral |
| Score | 1-3 | 4-7 | 8-10 | 1-3 | 4-7 | 8-10 | N/A |
| Background color | 1 | 2 | 3 | 4 | 5 | 6 | 7 |

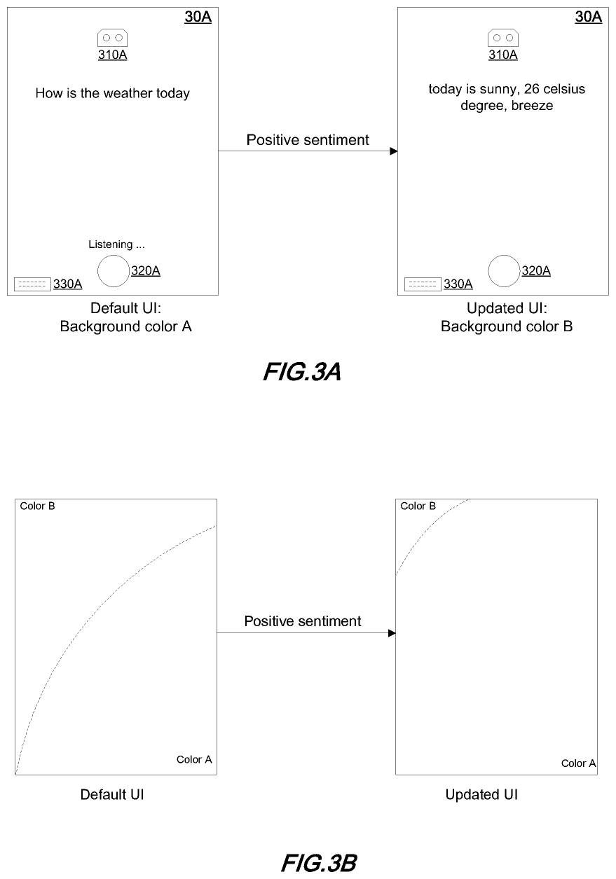

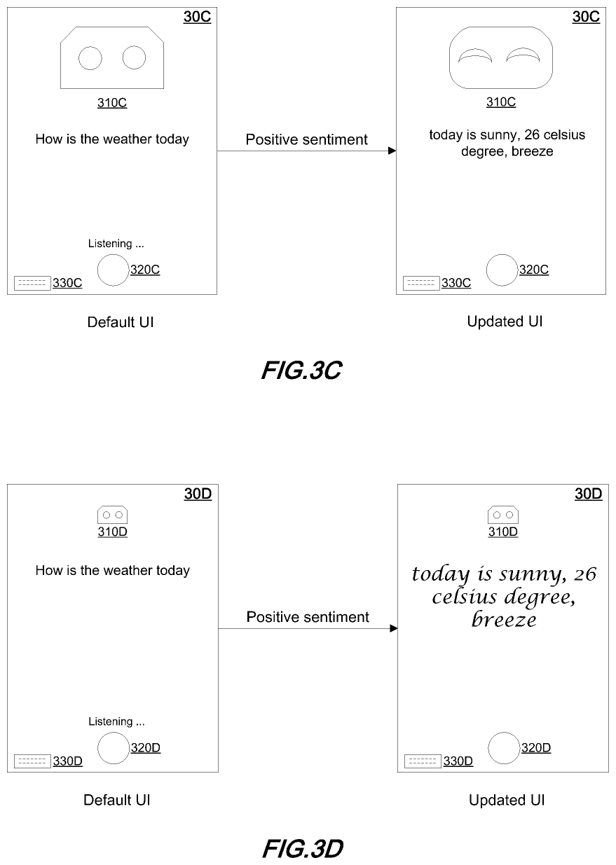

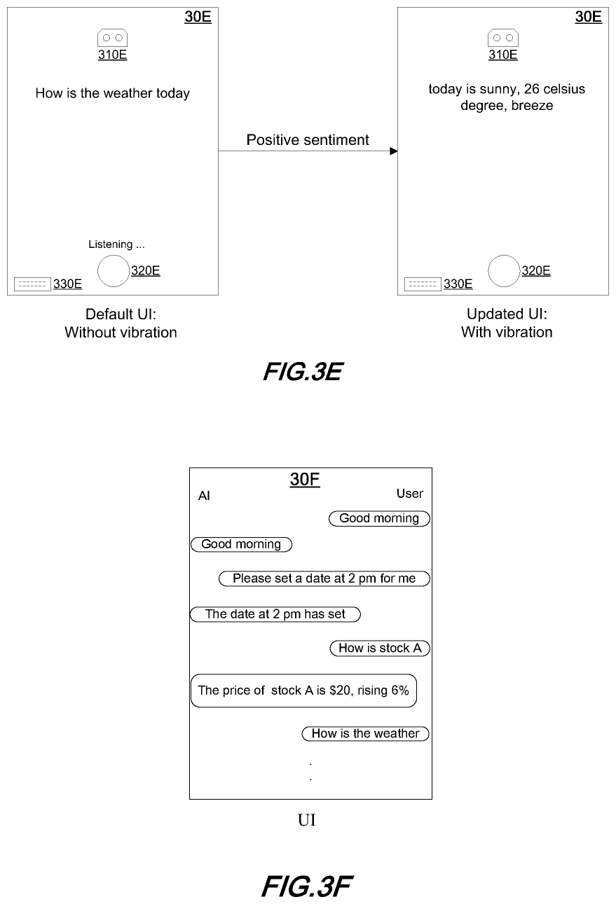

Table 4 shows an exemplary implementation of the mapping between the sentiment data to the UI configuration. The configuration of background color of the UI may be updated based on the sentiment data. As shown in table 4, different background colors may be configured for the UI based on the different sentiment data. Specifically, the sentiment data “type: positive, score: 1-3”, “type: positive, score: 4-7”, “type: positive, score: 8-10” may be mapped to background color 1, 2, 3 respectively, the sentiment data “type: negative, score: 1-3”, “type: negative, score: 4-7”, “type: negative, score: 8-10” may be mapped to background color 4, 5, 6 respectively, the sentiment data “type: neutral” may be mapped to background color 7. Therefore, after receiving the second content “today is sunny, 26 celsius degree, breeze” and the sentiment data “type: positive, score: 8”, the UI configuration, i.e. the background color configuration, may be updated as color 3 based on the sentiment data, and the second content may be outputted to the user through the updated UI having the updated background color 3. For example, as shown in FIG. 3A, the left side schematically shows the UI of the application in a default state, in which the background has a color A, and the right side schematically shows the updated UI of the application, in which the background has a color B.

Exemplary parameters of color may comprise hue, saturation, brightness, etc. The hue may be e.g., red, blue, purple, green, yellow, orange, etc. The saturation or the brightness may be a specific value or may be a predefined level such as low, mid or high. By configuring the parameters, it should be appreciated that color configurations having same hue with different saturation and/or brightness may be considered as different colors.

Different colors, for example, red, yellow, green, blue, purple, orange, pink, brown, grey, black, white and so on, may reflect or indicate different sentiments and sentiment intensities. Therefore the updating of background color based on the sentiment information of the content may provide a closer connection between the user and the application, so as to improve the user experience.

It should be appreciated that various variation of table 4 may be apparent for those skilled in the art. The sentiment types may be not limited to positive, negative and neutral, for example, the sentiment types may be Happy, Anger, Sadness, Disgust, Neutral, etc. There may be more or less score ranges and corresponding color configurations. The background color may be changed based only on the sentiment type irrespective of the sentiment scores, similarly as illustrated in table 2.

Although taking the background color as an example in table 4, the color may be applicable to various other kinds of UI elements, such as button, card, text, badge, etc.

TABLE 5

| | Type | | | | | | |
|---|---|---|---|---|---|---|---|
| | 1: positive | | | 2: negative | | | 3: neutral |
| Score | 1-3 | 4-7 | 8-10 | 1-3 | 4-7 | 8-10 | N/A |
| Background motion | 1 | 2 | 3 | 4 | 5 | 6 | none |

Table 5 shows an exemplary implementation of the mapping between the sentiment data to the UI configuration. The configuration of background motion of the UI may be updated based on the sentiment data. As shown in table 5, different background motion configurations correspond to different sentiment data. After receiving the second content “today is sunny, 26 celsius degree, breeze” and the sentiment data “type: positive, score: 8”, the UI configuration, i.e. the background motion effect configuration, may be updated as the configuration 3 based on the sentiment data, and the second content may be output to the user through the updated UI having the background motion effect 3.

The background motion configuration may include parameters such as color ratio, speed, frequency, etc. The parameters of each configuration may be predefined. By configuring these parameters of the UI of the application, a gradient motion effect of the UI background may be achieved. For example, as shown in FIG. 3B, the left side schematically shows the UI of the application in a default state. The dashed curve illustrates the ratio between color A and color B which originate from the right bottom corner and the left top corner of the UI respectively. It should be appreciated that the two parts of the color are not necessarily static, there may be some dynamic effect of the colors, for example, the two color areas may move back and forth slightly around their boundary line denoted by the dashed curve. After receiving a positive sentiment data as shown in the FIG. 3B, the UI configuration may be updated based on the sentiment data, for example, the background motion effect of the UI may be updated as the background motion effect configuration 3, in which the parameters such as color ratio, speed, frequency and so on are defined. As shown in the right side of the FIG. 3B, the second content may be outputted through the updated UI of the application. In the updated UI, the color A area expands at the speech defined in the configuration to the boundary denoted by the dashed curve and accordingly the color B area shrinks and the both areas move back and forth slightly around their boundary at the frequency defined in the configuration, while the second content is being outputted. A vivid gradient background color motion effect may be presented in order to reflect the positive sentiment, so as to achieve closer emotional connection between the user and the application.

In an implementation, after the second content is outputted through the updated UI of the application, the UI may be turned back to the default state. In an implementation, if negative sentiment is received, the boundary of the two areas may move to an opposite direction as compared to the case of positive sentiment. The shrink of the color A may provide a background color motion effect which reflects the negative sentiment. In an implementation, the color B at the left top may be that reflecting negative sentiment, such as white, gray, and black, and the color A at right bottom may be that reflecting positive sentiment, such as red, yellow, green, blue, purple.

The configurations of background motion effect may be predefined as shown in table 5, and may also be calculated according to the sentiment data. For example, the ratio of the color A to the color B may be determined using an exemplary equation (1):

$$ratio = \{ \begin{matrix}\frac{1}{2} + \frac{score}{2 * max of score} & if positive sentiment \\ \frac{1}{2} - \frac{score}{2 * max of score} & if negative sentiment\end{matrix} \qquad ( 1 )$$

Where the max of score is the maximum of the predetermined score range. The speed and frequency may also be determined according to the score of the sentiment in a similar way as shown in the equation (1). For example, the more positive the sentiment is, the faster the speed and/or the frequency is, the more negative the sentiment is, the slower the speed and/or the frequency is.

Although taking the background motion as an example in table 5, the motion configuration may be applicable to various other kinds of UI elements, such as icons, pictures, pages, etc. Examples of motion effect may include gradient motion effect, transition between pages, etc. Exemplary parameters of motion may comprise duration, movement tracks, etc. The duration indicates the time period of the motion effect lasts. The movement tracks define different shapes of the movement.

TABLE 6

| Type | 1 | 2 | 3 | 4 | 5 |
|---|---|---|---|---|---|
| Icon configuration | 1 | 2 | 3 | 4 | 5 |

Table 6 shows an exemplary implementation of the mapping between the sentiment data to the UI configuration. The configuration of icon of the UI may be updated based on the sentiment data. As shown in table 6, different icon shapes may be configured for the UI based on the different sentiment data such as sentiment types 1 to 5. The icon shapes may represent different sentiment such as Happy, Anger, Sadness, Disgust, Neutral, etc. As shown in FIG. 3C, after receiving the second content “today is sunny, 26 celsius degree, breeze” and the sentiment data “type: happy” which is a positive sentiment, the UI configuration, i.e. the configuration of the icon 310C, may be updated based on the sentiment data, for example, the eyes of the icon shape look like smiling and the outline of the icon is more rounded so as to present a happy mood to the user. The second content may be outputted to the user through the updated UI having the updated icon 310C.

The icon 310C may be a static icon, and may also be of an animation effect. Various animation patterns may be configured in the icon configurations for different sentiments. The various animation patterns may reflect happiness, sadness, anxious, relax, pride, envy and so on.

Although taking the personated icon as an example in FIG. 3C, other kinds of icons may be configured according to the sentiment data. For example, sharp angled icons may be used to reflect negative sentiment, and round angled icons may be used to reflect positive sentiment.

TABLE 7

| Type | 1 | 2 | 3 |
|---|---|---|---|
| Typography configuration | 1 | 2 | 3 |

Table 7 shows an exemplary implementation of the mapping between the sentiment data to the UI configuration. The configuration of typography of the UI may be updated based on the sentiment data. As shown in table 7, different typographies may be configured for the UI based on the different sentiment data such as sentiment types 1 to 3.

The typography may be applicable to text shown on the UI. Exemplary parameters of typography may comprise font size, font family, etc. Larger font size may present more positive sentiment, and smaller font size may present more negative sentiment. For example, the font size may be configured to be in proportion to the sentiment score for a positive sentiment type, and may be configured to be in reverse proportion to the sentiment score for a negative sentiment type. A more exaggerate font in the font family may present a more positive sentiment, and a more modest font in the font family may present a more negative sentiment. For example, characters in various fancy styles may be employed according to the sentiment data.

As shown in FIG. 3D, after receiving the second content “today is sunny, 26 celsius degree, breeze” and the sentiment data “type: happy” which is a positive sentiment, the typography may be updated to have a specific font with a specific font size based on the sentiment data, so as to present a happy mood to the user. The second content may be output to the user through the updated UI having the updated typography.

TABLE 8

| | Type | | | | |
|---|---|---|---|---|---|
| | 1: positive | | 2: negative | | |
| Score | 1-5 | 6-10 | 1-5 | 6-10 | 3: neutral |
| Taptic configuration | 1 | 2 | 3 | 4 | None |

Table 8 shows an exemplary implementation of the mapping between sentiment data and UI configurations. The taptic configuration of the UI may be updated based on the sentiment data. As shown in table 8, different taptic configurations may be set for the UI based on the different sentiment data such as sentiment types and scores. In this example, no score is provided for the type of neutral, and no taptic configuration is set for the type of neutral, but the subject matter is not limited to this example.

Taptic feedback such as vibration may be used to communicate different messages to the user. Exemplary parameters of the taptic feedback may comprise strength, frequency, duration, etc. Taking the vibration as the example of the taptic feedback, the strength defines the intensity of the vibration, the frequency defines the frequency of the vibration, and the duration defines how long the vibration would last. By defining at least part of the parameters, various vibration patterns may be implemented to convey sentiment to the user. For example, vibration with larger strength, frequency and/or duration may be used to present more positive sentiment, vibration with smaller strength, frequency and/or duration may be used to present more negative sentiment. As another example, the vibration may not be enabled for neutral or negative sentiment.

As shown in FIG. 3E, after receiving the second content “today is sunny, 26 celsius degree, breeze” and the sentiment data “type: happy, score: 6” which is a positive sentiment, the taptic configuration 2 may be employed based on the sentiment data to update the UI. Specifically, a vibration in a specific patter as defined in the taptic configuration 2 may be performed while outputting the second content “today is sunny, 26 celsius degree, breeze”. In other words, the second content may be outputted to the user through the updated UI having the vibration.

TABLE 9

| | Type | | | | |
|---|---|---|---|---|---|
| | 1: positive | | 2: negative | | |
| Score | 1-5 | 6-10 | 1-5 | 6-10 | 3: neutral |
| Depth configuration | 1 | 2 | 3 | 4 | None |

Table 9 shows an exemplary implementation of the mapping between sentiment data and UI configurations. The depth configuration of some elements of the UI may be updated based on the sentiment data.

The UI may be arranged in layers along an invisible Z axis which is perpendicular to the screen, and the elements may be arranged in the layers which have different depths. The depth parameter of a layer may comprise top, middle, bottom, etc. It should be appreciated that there may be more or less layers. For example, FIG. 3F shows a chitchat scenario between the AI and the user through the UI 30F. UI elements such as the message bubbles may have different depth which may be perceived as closer or more distant by the user. The closer a message bubble is perceived by the user, the more intimate it may be felt by the user. As shown in FIG. 3F, after a first content “how is stock A” is inputted by the user, a second content “The price of stock A is $20, rising 6%” together with positive sentiment data may be obtained in response to the first content at the cloud. After receiving the second content and the sentiment data at the client device, the depth of the message bubble used for the second content may be configured according to the sentiment data to make it be perceived closer to the user, as shown in FIG. 3F. Therefore by configuring a depth parameter of such a UI element based on the sentiment data, the UI may present a sentimental connection to the user.

Various examples of UI configuration based on sentiment data are described with reference to tables 1-9 and FIGS. 3A-3F, it should be appreciated that various suitable combinations of UI configurations in the examples may be implemented, and the element that may be configured based on the sentiment data is not limited to those described above.

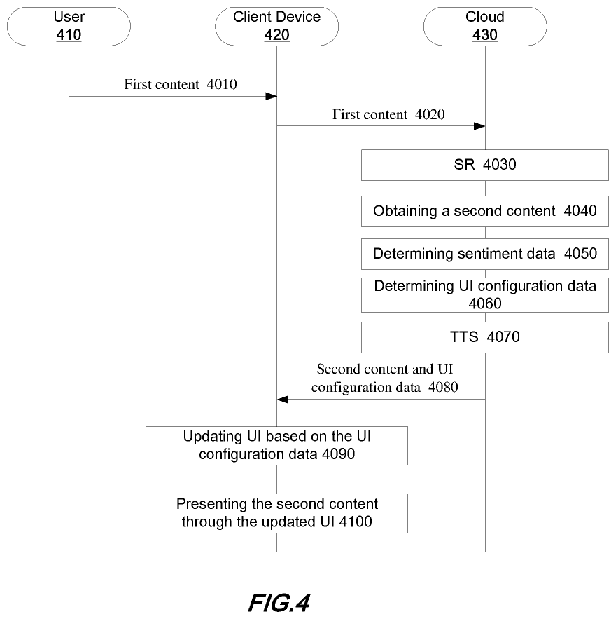

FIG. 4 illustrates an interaction process among a user, a client device and a cloud according to an embodiment of the subject matter.

Steps 4010-4050, 4070 and 4100 of FIG. 4 are similar to steps 2010-2060 and 2090 of FIG. 2, and thus the description about these steps is omitted for sake of simplicity.

At step 4060, UI configuration data may be determined based on the sentiment data at the cloud 430. The mapping of sentiment data to UI configurations as illustrated in tables 1-9 and FIGS. 3A-3F and any suitable combinations of them may be utilized to determine the UI configuration based on the sentiment data at the cloud 430.

At step 4080, the second content and the UI configuration data may be transmitted to the client device. As an implementation, the UI configurations and their indexes may be predefined, therefore only the index of the UI configuration determined at the step 4060 needs to be transmitted to the client device as the UI configuration data. The sentiment data which is transmitted at step 2070 of FIG. 2 and the UI configuration data which is transmitted at step 4080 of FIG. 3 may be collectively referred to as UI configuration related data.

At step 4090, the UI may be updated based on the UI configuration data, and at step 4100, the second content may be output or presented to the user through the updated UI.

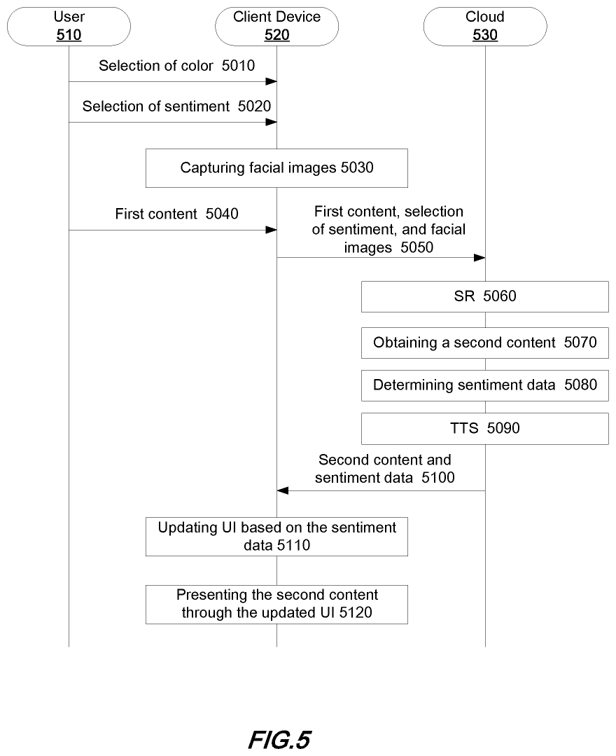

FIG. 5 illustrates an interaction process among a user, a client device and a cloud according to an embodiment of the subject matter.

Step 5040, 5060-5070 and 5090-5120 of FIG. 5 are similar to steps 2010, 2030-2040 and 2060-2090 of FIG. 2, and thus the description about these steps is omitted for sake of simplicity.

At step 5010, the user may select a color from among a plurality of colors available to be used as the background color of the UI. For example, the available colors may be provided as color icons on the UI. Therefore, a selection of a color from among a plurality of color icons arranged on the UI may be received by the application at the client device, and the color of the background of the UI may be changed based on the selection of the color.

At step 5020, the user may set a preferred or customized sentiment, which the user wants to receive from the AI. Therefore a selection of sentiment may be received by the application at the client device.

At step 5030, the application may capture facial images of the user for the purpose of analyzing the user's emotion. For example, a query may be prompted to the user “the APP want to use your front camera in order for providing you enhanced experience, allowed or not”, and if the user allows the use of camera, the APP may capture the facial images of the user by means of the front camera of the client device.

It should be appreciated that steps 5010 to 5030 are not necessary to be performed in sequence, and are not necessary to be performed all together.

At step 5050, the first content and at least one of the selected sentiment and the captured images may be sent to the cloud 530.

At step 5080, the sentiment data is determined based on at least one of the first content, the second content, the user customized sentiment configuration and the facial images of the user. As discussed above, the customized sentiment may be utilized at the cloud as a factor to determine the sentiment data. The user's facial images may be visually analyzed to estimate the user's emotion, and the emotion information of the user may be utilized at the cloud as a factor to determine the sentiment data. For example, even if no sentiment data is obtained based on the first and second content, a sentiment data may be determined based on the user selected sentiment and/or the estimated user emotion. As another example, user selected sentiment and/or the estimated user emotion may add a weight to the process of calculating sentiment data based on the first and/or second content. Any combination of the first content, the second content, the user customized sentiment configuration and the facial images of the user may be utilized to determine the sentiment data at step 5080.

As an alternative implementation of FIG. 5, the step 4060 of FIG. 4 may be performed at the cloud 530 at FIG. 5. It should be appreciated that the steps shown in FIGS. 2, 4 and 5 may be combined in various suitable ways, which may be apparent to those skilled in the art.

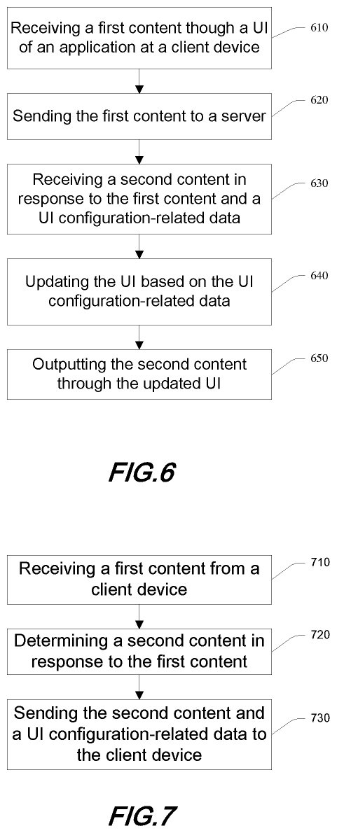

FIG. 6 illustrates a process for sentiment based interaction according to an embodiment of the subject matter.

At 610, a first content may be received through a UI of an application at a client device. At 620, the first content may be sent to a cloud, which may also be referred to as a server. At 630, a second content in response to the first content and a UI configuration-related data may be received from the server. At 640, the UI may be updated based on the UI configuration-related data. At 650, the second content may be outputted through the updated UI. In this way, a sentiment-based closer connection with the user may be established during the interaction with the user.

In an implementation, the UI configuration-related data may comprise at least one of a sentiment data and a UI configuration data determined based on the sentiment data. The sentiment data may be determined based on at least one of the first content and the second content. The sentiment data may comprise at least one sentiment type and at least one corresponding sentiment intensity.

In an implementation, at least one element of the UI may be updated based on the UI configuration-related data, wherein the at least one element of the UI comprises at least one of color, motion effect, icon, typography, relative position, taptic feedback. For example, gradient background color motion parameters of the UI may be changed based on the UI configuration-related data, wherein the gradient background color motion parameters may comprise at least one of color ratio, speed and frequency which are determined based on the sentiment data.

In an implementation, a selection of a color may be received from among a plurality of color icons arranged on the UI, and the color of the background of the UI may be changed based on the selection of the color.

In an implementation, a user customized sentiment configuration may be received, and/or facial images of a user may be captured at the client device. The user customized sentiment configuration and/or the facial images of the user may be sent from the client device to the server. And the sentiment data may be determined based on at least one of the first content, the second content, the user customized sentiment configuration and the facial images of the user.

FIG. 7 illustrates a process for sentiment based interaction according to an embodiment of the subject matter.

At 710, a first content may be received from a client device. At step 720, a second content may be obtained in response to the first content. At step 730, the second content and a UI configuration-related data may be transmitted to the client device.

In an implementation, the UI configuration-related data may comprise at least one of a sentiment data and a UI configuration data determined based on the sentiment data. The sentiment data may be determined based on at least one of the first content and the second content.

In an implementation, at least one of a sentiment configuration and facial images may be received from the client device. The sentiment data may be determined based on at least one of the first content, the second content, the sentiment configuration and the facial images.

FIG. 8 illustrates an apparatus 80 for sentiment-based interaction according to an embodiment of the subject matter. The apparatus 80 may include an interacting module 810 and a communicating module 820.

The interacting module 810 may be configured to receive a first content through a UI of an application. The communicating module 820 may be configured to transmit the first content to a server, and receive a second content in response to the first content and a UI configuration-related data from the server. The interacting module 810 may be further configured to update the UI based on the UI configuration-related data, and output the second content through the updated UI.

It should be appreciated the interacting module 810 and the communicating module 820 may be configured to perform the operations or functions at the client device described above with reference to FIGS. 1-7.

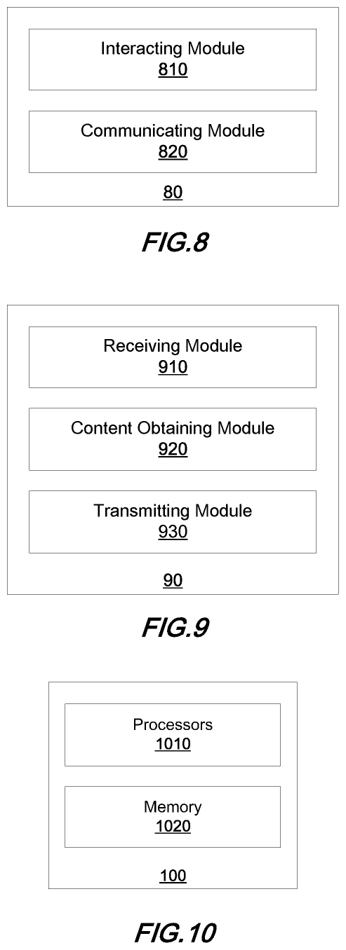

FIG. 9 illustrates a system 90 for sentiment-based interaction according to an embodiment of the subject matter. The system 90 may be an AI system as illustrated in FIGS. 1A and 1B. The system 90 may include a receiving module 910, a content obtaining module 920 and a transmitting module 930.

The receiving module 910 may be configured to receive a first content from a client device. The content obtaining module 920 may be configured to obtain a second content in response to the first content. The transmitting module 930 may be configured to transmit the second content and a UI configuration-related data to the client device.

It should be appreciated the modules 910 to 930 may be configured to perform the operations or functions at the cloud described above with reference to FIGS. 1-7.

It should be appreciated that modules and corresponding functions described with reference to FIGS. 1A, 1B, 8 and 9 are for sake of illustration rather than limitation, a specific function may be implemented in different modules or in a single module.

The respective modules as illustrated in FIGS. 1A, 1B, 8 and 9 may be implemented in various forms of hardware, software or combinations thereof. In an embodiment, the modules may be implemented separately or as a whole by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. In another embodiment, the modules may be implemented by one or more software modules, which may be executed by a general central processing unit (CPU), a graphic processing unit (GPU), a Digital Signal Processor (DSP), etc.

FIG. 10 illustrates a computer system 100 for sentiment-based interaction according to an embodiment of the subject matter. According to one embodiment, the computer system 100 may include one or more processors 1010 that execute one or more computer readable instructions stored or encoded in computer readable storage medium such as memory 1020.

In an embodiment, the computer-executable instructions stored in the memory 1020, when executed, may cause the one or more processors to: receive a first content through a UI of an application, send the first content to a server, receive a second content in response to the first content and a UI configuration-related data from the server, update the UI based on the UI configuration-related data, and output the second content through the updated UI.

In an embodiment, the computer-executable instructions stored in the memory 1020, when executed, may cause the one or more processors to: receive a first content from a client device, obtain a second content in response to the first content, determine a sentiment data based on at least one of the first content and the second content, and send the second content and the sentiment data to the client device.

It should be appreciated that the computer-executable instructions stored in the memory 1020, when executed, may cause the one or more processors 1010 to perform the respective operations or functions as described above with reference to FIGS. 1 to 9 in various embodiments of the subject matter.

According to an embodiment, a program product such as a machine-readable medium is provided. The machine-readable medium may have instructions thereon which, when executed by a machine, cause the machine to perform the operations or functions as described above with reference to FIGS. 1 to 9 in various embodiments of the subject matter.

It should be noted that the above-mentioned solutions illustrate rather than limit the subject matter and that those skilled in the art would be able to design alternative solutions without departing from the scope of the appended claims. In the claims, any reference signs placed between parentheses shall not be construed as limiting the claim. The word “comprising” does not exclude the presence of elements or steps not listed in a claim or in the description. The word “a” or “an” preceding an element does not exclude the presence of a plurality of such elements. In the system claims enumerating several units, several of these units can be embodied by one and the same item of software and/or hardware. The usage of the words first, second and third, et cetera, does not indicate any ordering. These words are to be interpreted as names.

1. A method for interaction, comprising:
receiving a first content through a user interface (UI) of an application;
sending the first content to a server;
receiving a second content in response to the first content and a UI configuration-related data from the server;
updating the UI based on the UI configuration-related data; and
outputting the second content through the updated UI.

2. The method of claim 1, wherein the UI configuration-related data comprises at least one of a sentiment data and a UI configuration data determined based on the sentiment data.

3. The method of claim 2, wherein the sentiment data is determined based on at least one of the first content and the second content.

4. The method of claim 2, wherein the sentiment data comprises at least one sentiment type and at least one corresponding sentiment intensity.

5. The method of claim 1, wherein the updating the UI comprises:
updating at least one element of the UI based on the UI configuration-related data, wherein the at least one element of the UI comprises at least one of color, motion effect, icon, typography, relative position, taptic feedback.

6. The method of claim 5, wherein updating the motion effect comprises:
changing gradient background color motion parameters of the UI based on the UI configuration-related data, wherein the gradient background color motion parameters comprise at least one of color ratio, speed and frequency.

7. The method of claim 2, further comprising:
performing at least one of the following operations:
receiving a user customized sentiment configuration; and
capturing facial images of a user; and
sending at least one of the user customized sentiment configuration and the facial images of the user to the server, wherein the sentiment data is determined based on at least one of the first content, the second content, the user customized sentiment configuration and the facial images of the user.

8. A method for interaction, comprising:
receiving a first content from a client device;
determining a second content in response to the first content; and
sending the second content and a user interface (UI) configuration-related data to the client device.

9. The method of claim 8, wherein the UI configuration-related data comprises at least one of a sentiment data and a UI configuration data determined based on the sentiment data.

10. The method of claim 9, further comprising:
determining the sentiment data based on at least one of the first content and the second content.

11. The method of claim 9, further comprising:
receiving at least one of a sentiment configuration and facial images from the client device; and
determining the sentiment data based on at least one of the first content, the second content, the sentiment configuration and the facial images.

12. An apparatus for interaction, comprising:
an interacting module configured to receive a first content through a user interface (UI) of an application; and
a communicating module configured to transmit the first content to a server, and receive a second content in response to the first content and a UI configuration-related data from the server;
the interacting module is further configured to update the UI based on the UI configuration-related data, and output the second content through the updated UI.

13. The apparatus of claim 12, wherein the UI configuration-related data comprises at least one of a sentiment data and a UI configuration data determined based on the sentiment data.

14. The apparatus of claim 13, wherein the sentiment data is determined based on at least one of the first content and the second content.

15. The apparatus of claim 12, wherein the interacting module is further configured to:
update at least one element of the UI based on the UI configuration-related data, wherein the at least one element of the UI comprises at least one of color, motion effect, icon, typography, relative position, taptic feedback.

16. The apparatus of claim 15, wherein the interacting module is further configured to:
change gradient background color motion parameters of the UI based on the UI configuration-related data, wherein the gradient background color motion parameters comprise at least one of color ratio, speed and frequency.

17. The apparatus of claim 13, wherein the interacting module is further configured to perform at least one of the following operations:
receiving a user customized sentiment configuration; and
capturing facial images of a user; and
wherein the communicating module is further configured to send at least one of the user customized sentiment configuration and the facial images of the user to the server, wherein the sentiment data is determined based on at least one of the first content, the second content, the user customized sentiment configuration and the facial images of the user.

18-20. (canceled)
